(19) United States
(12) Patent Application Publication
(10) Pub. No.: US 2013/0020489 A1
(43) Pub. Date: Jan. 24, 2013

(54) COINCIDENCE DETERMINATION METHOD AND APPARATUS FOR PET DEVICE

(71) Applicants: Eiji Yoshida, Chiba-shi (JP); Taiga Yamaya, Chiba-shi (JP)

(72) Inventors: Eiji Yoshida, Chiba-shi (JP); Taiga Yamaya, Chiba-shi (JP)

(73) Assignee: NATIONAL INSTITUTE OF RADIOLOGICAL SCIENCES, Chiba-shi, Chiba (JP)

(21) Appl. No.: 13/639,346

(22) PCT Filed: Apr. 6, 2010
(86) PCT No.: PCT/JP2010/056254

§ 371 Date: Oct. 4, 2012

(51) Int. Cl. G01T 1/164

(52) U.S. Cl. 250/362; 250/363.03

(57) ABSTRACT

For coincidence determination, a PET device that regards and counts a pair of annihilation radiations detected within a predetermined time as occurring from the same nuclide changes a coincidence time width according to a maximum detection time difference. This prevents the inclusion of extra noise data for improved image quality.

### TECHNICAL FIELD

The present invention relates to a coincidence determination method and apparatus for a PET device, and more particularly to a coincidence determination method and apparatus for a PET device which are suitably used for a PET device that widely covers a whole body, and can make full use of potentiality of such a PET device.

### BACKGROUND ART

Current PET devices typically include a ring-type arrangement of detectors with a length of 15 cm or so, which can only image a part of a subject at a time. For purposes such as improving test throughput, like shown in FIG. 1 (a sectional view seen from a side) and FIG. 2 (a sectional view seen from the front and a block diagram), a PET device 20 that covers as much area of the whole body of a subject 10 as possible has been under research and development (see Non-Patent Literature 1 and Non-Patent Literature 2).

As shown in FIG. 2, a coincidence method used in a typical PET device is a detection method of determining a pair of annihilation radiations 14 detected within an extremely short time of around several nanoseconds to be a true coincidence occurring from the same positron nuclide 12. A technique for making a coincidence determination by lookup table (see Non-Patent Literatures 3 and 4), called a time stamp method, is typically used and can be implemented by hardware using simple logic.

In the drawings, 22 denotes detector rings (hereinafter, also referred to simply as rings) that constitute the PET device 20 and include a plurality of radiation detectors (hereinafter, also referred to simply as detectors) which are arranged on a circumference, for example; 24 denotes position and time information detection sections that detect detected positions and time information of radiations in the respective detectors; and 26 denotes a coincidence section that determines a coincidence to be present if a difference in detection time between a plurality of detectors 22 falls within a predetermined coincidence time width.

A PET device that covers as much area of a whole body as possible can image the whole body with high sensitivity. To acquire complete data by a conventional coincidence technique such as shown in FIG. 3, the time width for determining coincidence (coincidence time width) at step 100 needs to be increased. This entails acquisition of extra noise data (random coincidence) and fails to make full use of the potentiality of the PET device.

The coincidence time width for determining a positron nuclide is determined by the timing resolution and the size of the field of view of the PET device. At present, PET devices having an improved timing resolution of around 500 picoseconds are developed. Annihilation radiations occurring in the center of the field of view are detected with a small time difference. The detection time difference increases as the position of the positron nuclide deviates from the center of the field of view. The detection time difference with which annihilation radiations reach detectors thus depends on the timing resolution and the size of the field of view. A PET device that widely covers a whole body also produces a time difference because of a ring difference between the detectors to detect (the distance between the detector rings for a respective pair of annihilation radiations to reach) aside from the timing resolution and the size of the field of view. FIG. 4 shows the relationship between the position of a radiation source and the maximum detection time difference TD on a line of response (in FIG. 4, the ring diameter R is set to 66 cm; timing resolution is not taken into account). In the chart, the symbol □ represents the case of an offset of 0 cm, the symbol ∘ 5 cm, the symbol Δ 10 cm, and the symbol □ 15 cm. The chart reveals that the detection time difference TD increases as the offset increases and as the line of response has a greater ring difference Rd.

Patent Literatures 1 and 2 propose a method for improving the S/N of a PET/CT device by calculating the size of an object to be measured by using CT in advance and setting coincidence time widths for lines of response that have respective different maximum detection time differences. However, the technique needs optimization of coincidence time widths for each object to be measured, while detection time differences within a cross section are limited under the time resolution of 500 ps or so. Besides, the technique absolutely requires CT information and is difficult to implement by hardware.

### CITATION LIST

### Patent Literature

Patent Literature 1: U.S. Pat. No. 7,402,807 B2
Patent Literature 2: U.S. Patent Application Laid-Open Publication No. 20070106154 A1

### Non-Patent Literature

Non-Patent Literature 1: M. Watanabe, et al., IEEE Trans. Nucl. Sci., vol. 51, 796-800, 2004.
Non-Patent Literature 2: L. Eriksson, et al., Nucl. Instr. Meth. A, vol. 580, 836-842, 2007.
Non-Patent Literature 3: H. M. Dent, W. F. Jones, and M. E. Casey, “A real time digital coincidence processor for positron emission tomography”, IEEE Trans. Nucl. Sci. Vol. 33, 556-559, 1986
Non-Patent Literature 4: D. F. Newport, H. M. Dent, M. E. Casey, and D. W. Bouldin, “Coincidence Detection and Selection in Positron Emission Tomography Using VLSI”, IEEE Trans. Nucl. Sci. Vol. 36, 1052-1055, 1989
Non-Patent Literature 5: T. Yamaya, T. Inaniwa, S. Minohara, E. Yoshida, N. Inadama, F. Nishikido, et al., Phys. Med. Biol., vol. 53, 757-773, 2008

### SUMMARY OF INVENTION

### Problem to be Solved by the Invention

A PET device that widely covers a whole body is capable of high sensitive imaging by covering as much area of a subject with rings as possible. This greatly enlarges ring differences, however, and effective use needs to be made of oblique lines of response. As compared to conventional PET devices, oblique lines of response reach detectors with greater time differences. Simply increasing the coincidence time width can degrade image quality due to the acquisition of extra noise data. Moreover, since the PET device that widely covers a whole body has high sensitivity, an extremely large amount of data needs to be acquired as compared to a conventional PET device.

### Solution to Problem

Aside from the timing resolution, the maximum detection time difference of an arbitrary coincidence depends on the distance for which the line of response passes the field of view. The coincidence time width needed for each coincidence can be calculated in advance from the geometrical arrangement of the detectors and the size of the field of view. For an arbitrary coincidence, a radiation source that produces the maximum detection time difference falls on an intersection with the field of view. FIG. 5 shows examples of the line of response whose radiation source lies at an outermost position in the field of view. The detection time differences of the respective lines of response increase in the order of C<B<A. The inclusion of extra noise data can thus be avoided by calculating the maximum detection time difference from the geometrical arrangement and the size of the field of view of the PET device and setting the coincidence time width for each line of response. Note that the object to be imaged typically lies near the center of the field of view, and detection time differences within a cross section are limited. The PET device that widely covers a whole body can also produce a large detection time difference due to a ring difference of the line of response detected. As also shown in FIG. 4, the maximum detection time difference TD in the direction of the body axis is defined by the following equation:

$$TD = \frac{\sqrt{{Rd}^{2} + {R}^{2}} \times offset}{c \times R} + 2 \times TR \qquad ( 1 )$$

Here, Rd is the ring difference, R is the ring diameter, offset is the offset from the center of the field of view, c is the velocity of light, and TR is the timing resolution of the detectors.

The detection time difference based on the ring difference is determined by the geometrical arrangement of the detector rings and can thus be calculated in advance.

The present invention has been achieved in view of the foregoing. The present invention solves the foregoing problems by the provision of a coincidence determination method for a PET device that regards and counts a pair of annihilation radiations detected within a predetermined time as occurring from the same nuclide, the method including changing a coincidence time width according to a maximum detection time difference.

Here, the maximum detection time difference may be calculated in advance according to a geometrical arrangement of detectors and a size of a field of view.

The maximum detection time difference may be calculated in advance according to a ring difference that is a distance between detector rings for the respective pair of annihilation radiations to reach.

The present invention also solves the foregoing problems by the provision of a coincidence determination method for a

PET device that regards and counts a pair of annihilation radiations detected within a predetermined time as occurring from the same nuclide, the method including changing a maximum detection time difference and/or a coincidence time width according to a ring difference that is a distance between detector rings for the respective pair of annihilation radiations to reach.

The present invention also provides a coincidence determination apparatus for a PET device, including:

a plurality of radiation detectors for detecting radiations occurring from a nuclide;

means for detecting detection times of radiations in the respective radiation detectors;

means for determining a coincidence to be present when a difference in detection time between a plurality of the radiation detectors is within a predetermined time; and

means for changing a coincidence time width according to a maximum detection time difference.

The present invention also provides a coincidence determination apparatus for a PET device including:

a plurality of radiation detectors for detecting radiations occurring from a nuclide;

means for detecting detection times of radiations in the respective radiation detectors;

means for determining a coincidence to be present when a difference in detection time between a plurality of the radiation detectors is within a predetermined time; and

means for changing a coincidence time width according to a ring difference that is a distance between detector rings for a respective pair of annihilation radiations to reach.

### Advantageous Effects of Invention

According to the present invention, an appropriate coincidence time width is set according to a ring difference. This can prevent the inclusion of extra noise data.

According to the present invention, as shown in FIG. 6, the coincidence time width may be reduced, for example, stepwise for lines of response with smaller ring differences as far as the field of view can be secured. This can prevent the inclusion of extra noise data and improve the image quality of a PET device that widely covers a whole body.

The present invention can be one of elemental technologies for achieving a PET device that widely covers a whole body. The present invention can be used to make full use of the potentiality of the PET device that widely covers a whole body.

The present invention can be implemented by adding only a detection time difference calculation section and a ring difference determination section to a conventional coincidence circuit system, and is thus suited to hardware-based online processing.

As shown in FIG. 7, the detection rings may be (a) a perfectly ring-shaped one, (b) one with some detectors removed, and (c) rings with a gap therebetween. Such rings can be similarly handled as a virtual ring.

### BRIEF DESCRIPTION OF DRAWINGS

FIG. 1 is a sectional view seen from a side, showing an example of the configuration of a PET device.

FIG. 2 is a sectional view of the same, seen from the front, and a block diagram including a coincidence circuit system.

FIG. 3 is a flowchart showing conventional coincidence determination processing.

FIG. 4 is a diagram showing the relationship between detected positions and a maximum detection time difference.

FIG. 5 shows examples of lines of response whose radiation sources lie at outermost positions in the field of view.

FIG. 6 is a diagram showing the relationship between a ring difference and a maximum detection time difference according to the present invention.

FIG. 7 is a perspective view showing various examples of the detector ring of a PET device.

FIG. 8 is a block diagram showing the configuration of an embodiment of a coincidence determination system according to the present invention.

FIG. 9 is a flowchart showing coincidence determination processing in the same embodiment.

FIG. 10 is a diagram showing the relationship between a coincidence time width and detection time difference tags in the same embodiment.

FIG. 11 is a diagram showing the relationship between a maximum ring difference and ring difference tags in the same embodiment.

FIG. 12 is a diagram showing an example of a table of maximum detection time differences in the same embodiment.

FIG. 13 is a chart showing the effect of improving the image quality of a cylindrical phantom according to an example.

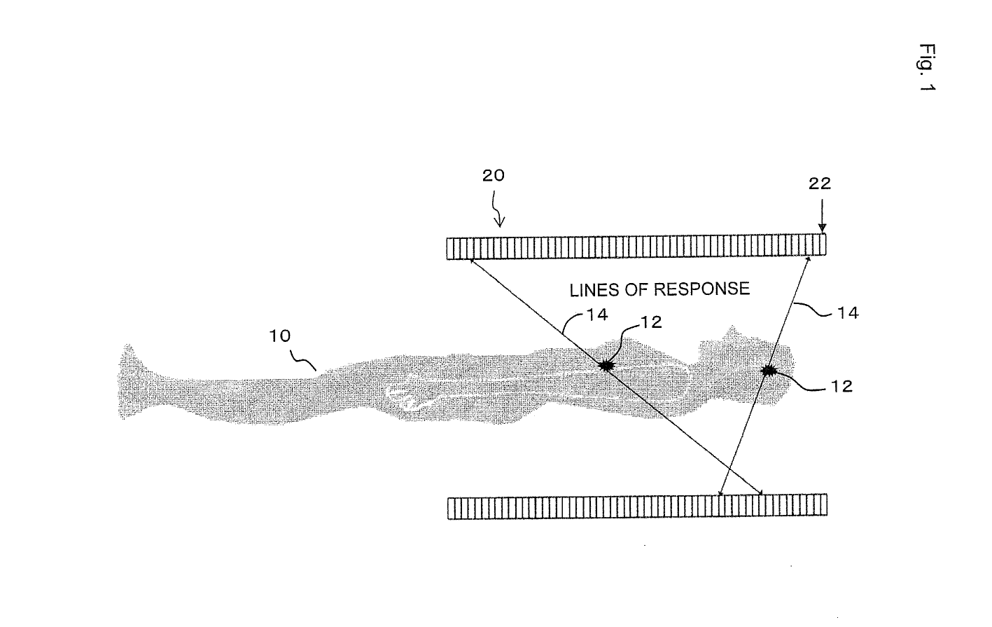

### DESCRIPTION OF EMBODIMENTS

Hereinafter, an embodiment of the present invention will be described in detail with reference to the drawings.

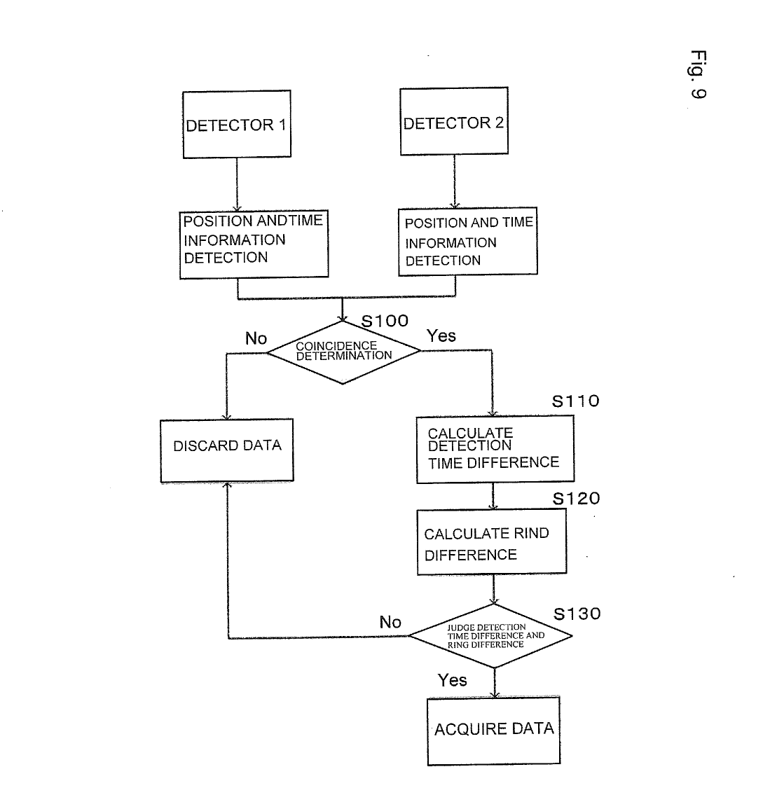

FIG. 8 is a block diagram showing the configuration of a coincidence determination system according to the present embodiment. FIG. 9 is a flowchart for explaining coincidence determination processing in the same embodiment.

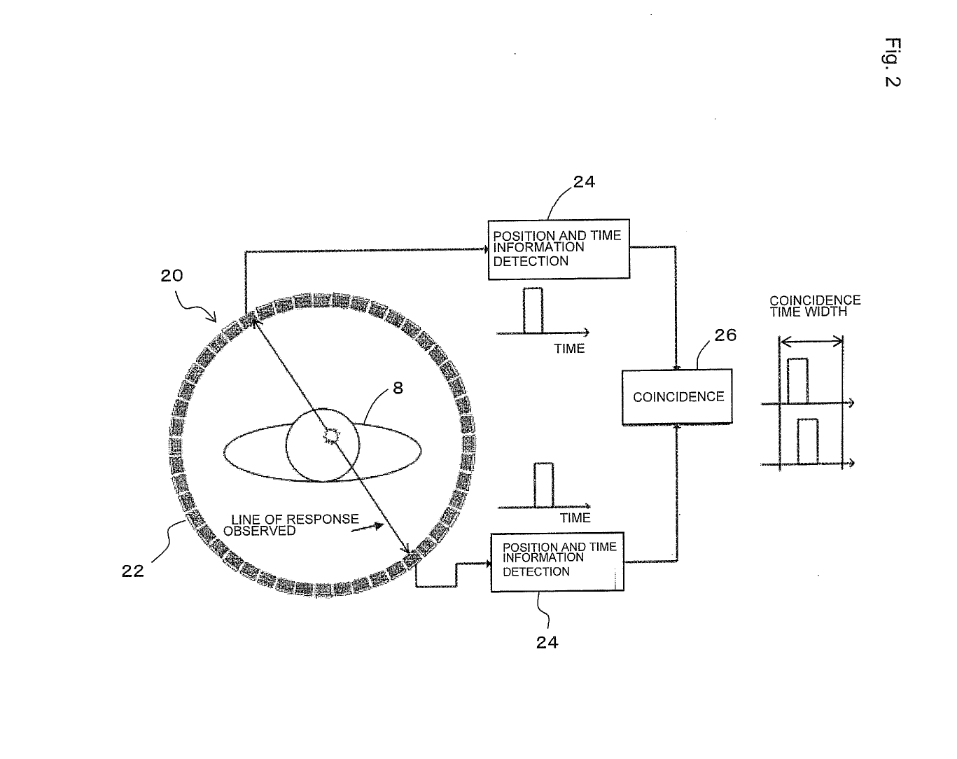

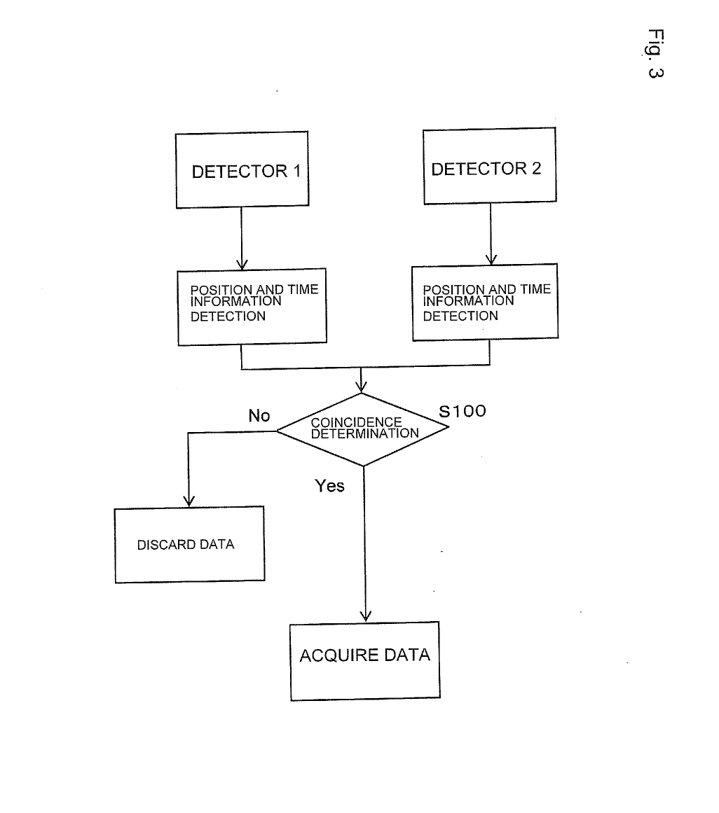

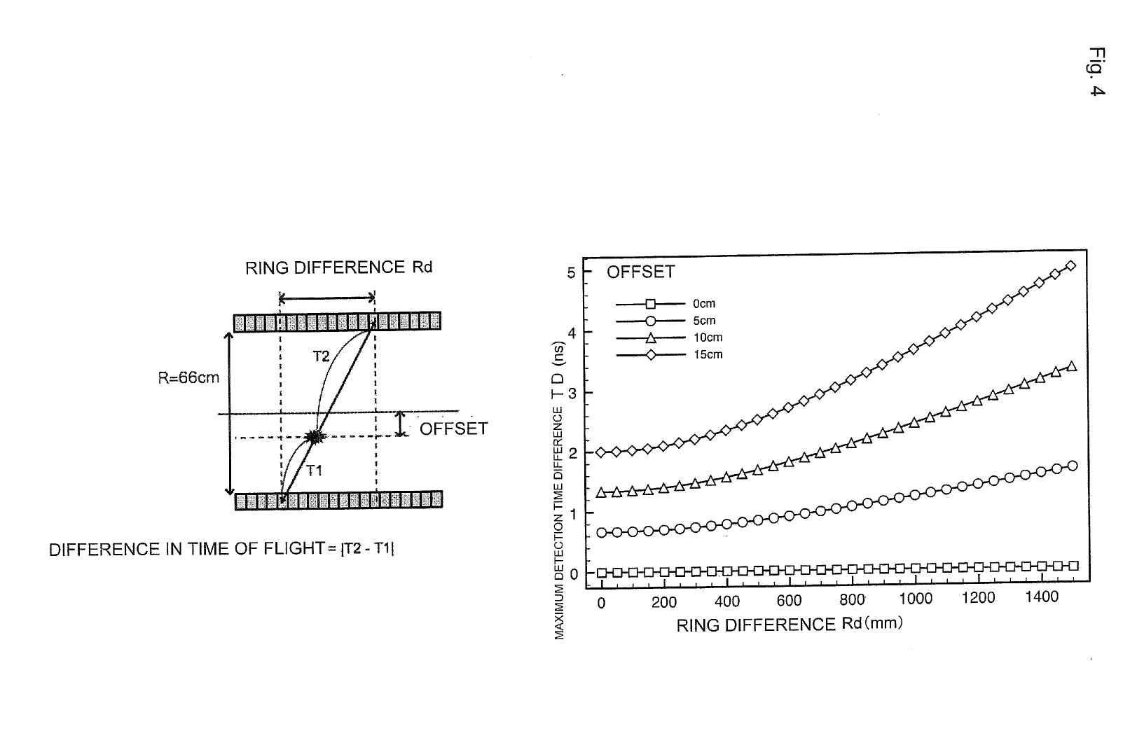

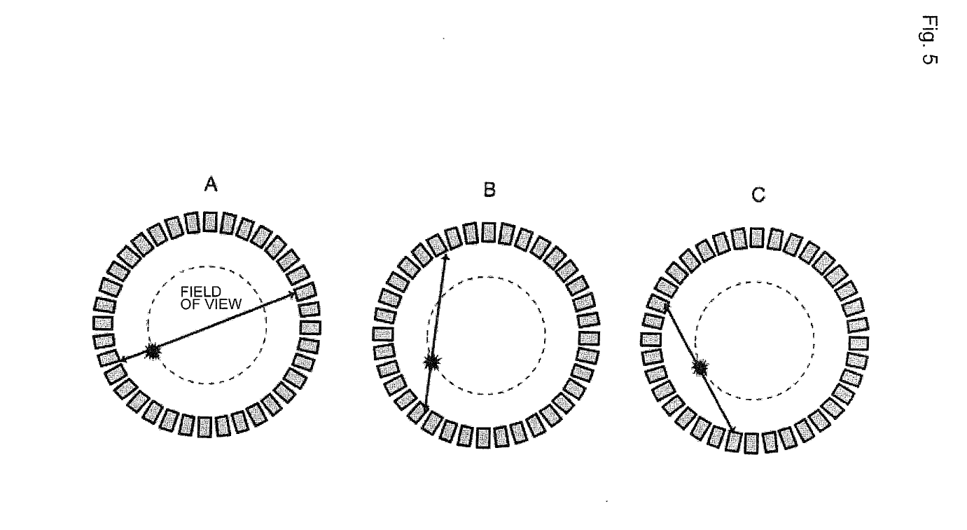

The coincidence determination system shown in FIG. 8 includes the same coincidence section 26 as in the conventional example shown in FIG. 2, a detection time difference calculation section 30, a ring difference calculation section 32, and a determination 34S.

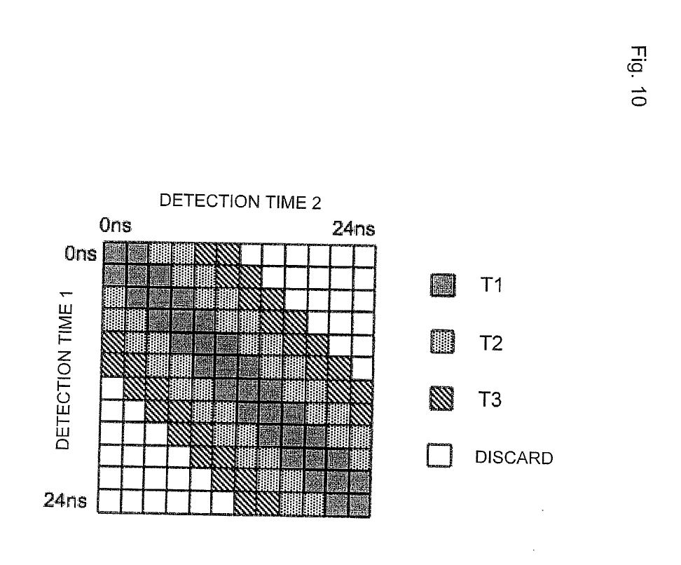

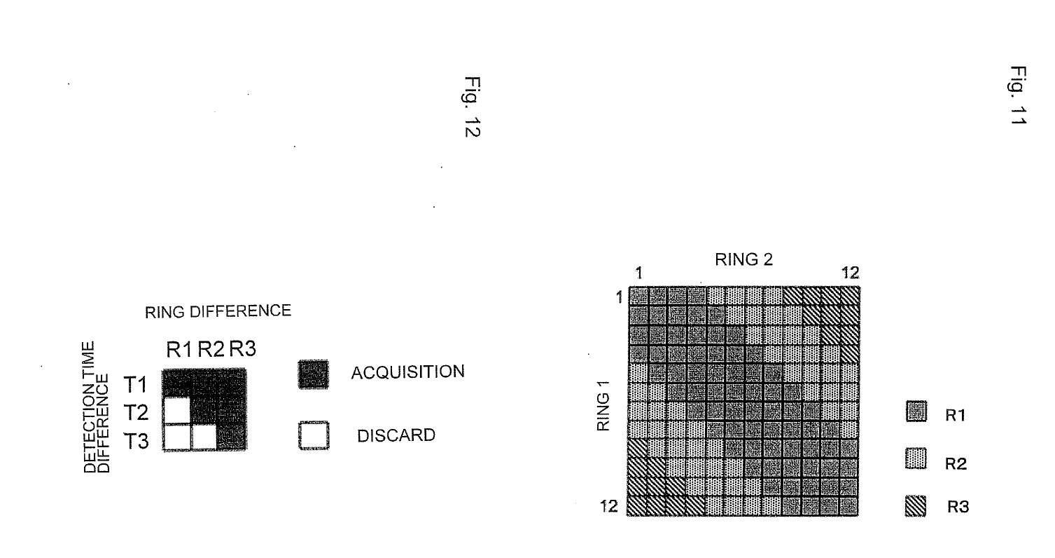

FIG. 9 shows an example of data processing according to the present invention when a coincidence time determination width is divided based on a ring difference. Suppose that the number of rings is 12 and a coincidence time width of 12 ns is divided into three, 4 ns each. The detection time difference calculation section 30 has three separate tags (T1, T2, and T3) based on the coincidence time determination width as shown in FIG. 10. Similarly, the ring difference calculation section 32 has three separate tags (R1, R2, and R3) based on a maximum ring difference as shown in FIG. 11. For example, the detection time difference tags and the ring difference tags have restrictions such that T1<T2<T3 and R1<R2<R3, respectively.

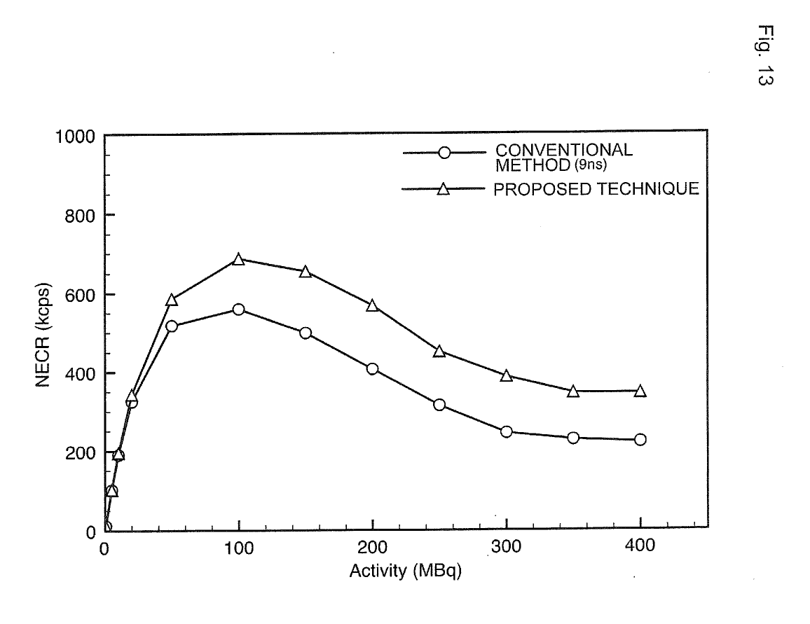

The detection time difference calculation section 30 calculates a detection time difference (step 110). The ring difference calculation section 32 calculates a ring difference (step 120). The determination section 34 judges the detection time difference and the ring difference (step 130). Data can thus be acquired with an optimum coincidence time width for each ring difference. The determination section 34 may create a table of maximum detection time differences allowable for respective ring differences such as shown in FIG. 12 in advance. The determination section 34 can consult determined ring difference tags and detection time difference tags to acquire data with optimum coincidence time widths for respective ring differences.

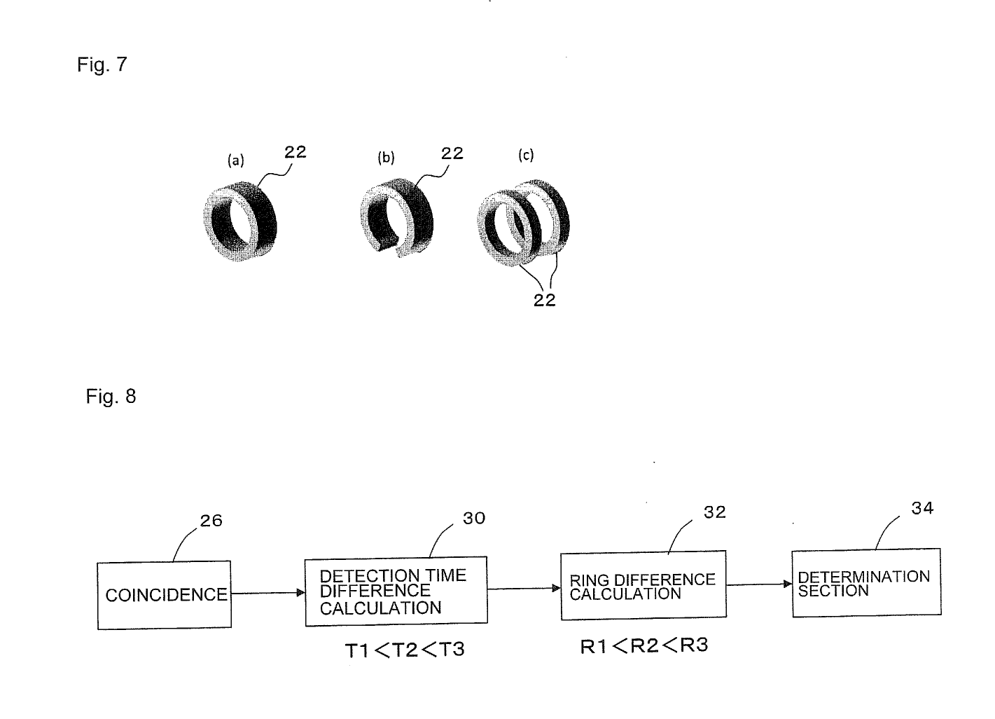

A PET device that widely covers a whole body includes an enormous number of detectors. The technique of an open PET device (see Non-Patent Literature 5) may be able to be used to create a gap between detector rings as in FIG. 7(c) for cost reduction. Images of the gap between the detector rings are calculated only from oblique lines of response. The present invention enables a coincidence determination optimum for the device system.

### EXAMPLE

A simulation of a PET device that widely covers a whole body was performed. The device used block detectors including an array of 2.9×2.9×20-mm-thick LSO scintillators to constitute a multiple detector ring having a ring diameter of 66 cm and a length of 120 cm. A cylindrical phantom of 20 cm in diameter and 1 m in length was placed in the ring center.

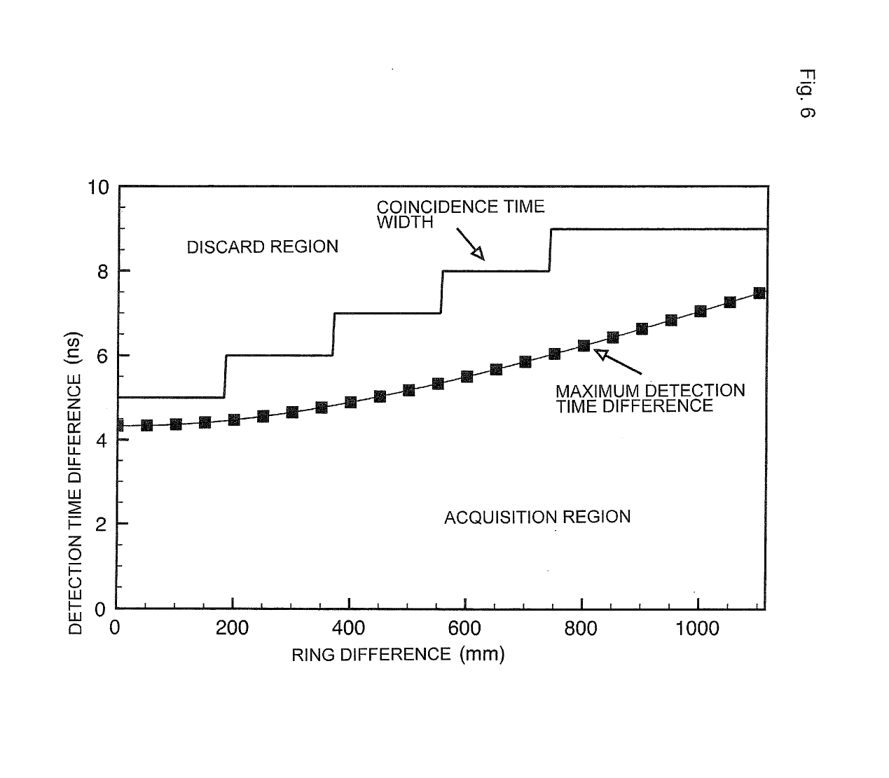

The detectors had a timing resolution of 500 picoseconds and a coincidence time width of 9 nanoseconds. FIG. 6 shows the relationship between the ring difference and the maximum detection time difference according to the example. Five steps of thresholds were set for the maximum detection time difference, depending on the ring difference.

FIG. 13 shows noise equivalent count rates (NECR) under the application of the present invention (see S. C. Strother, M. E. Casey, E. J. Hoffman, IEEE Trans. Nucl. Sci., vol. 37, 783-788, 1990).

NECR is an index for evaluating the image quality of a cylindrical phantom. NECR, frequently used to evaluate the performance of a PET device, is expressed by the following equation:

NECR=T²/(T+S+R) (2)

Here, T is the true coincidence rate, S is the scatter coincidence rate, and R is the random coincidence rate. The result suggested that the application of the present invention improves image quality.

### INDUSTRIAL APPLICABILITY

At present, a PET device that widely covers a whole body has not been practiced yet in terms of cost, an increased amount of data to be processed, etc. There is a good possibility, however, that such problems can be solved by technological innovation in the future. If a PET device that widely covers a whole body is realized, the optimization of the coincidence determination technique will be needed and the present invention will be able to be applied.

### REFERENCE SIGNS LIST

10 . . . imaging target

12 . . . positron nuclide

20 . . . PET device

22 . . . detector ring

24 . . . position and time information detection section

26 . . . coincidence section

30 . . . detection time difference calculation section

32 . . . ring difference calculation section

34 . . . determination section

1. A coincidence determination method for a PET device that regards and counts a pair of annihilation radiations detected within a predetermined time as occurring from the same nuclide, the method comprising:
changing a coincidence time width according to a maximum detection time difference.

2. The coincidence determination method for a PET device according to claim 1, wherein the maximum detection time difference is calculated in advance according to a geometrical arrangement of detectors and a size of a field of view.

3. The coincidence determination method for a PET device according to claim 1, wherein the maximum detection time difference is calculated in advance according to a ring difference that is a distance between detector rings for the respective pair of annihilation radiations to reach.

4. A coincidence determination method for a PET device that regards and counts a pair of annihilation radiations detected within a predetermined time as occurring from the same nuclide, the method comprising:
changing a coincidence time width according to a ring difference that is a distance between detector rings for the respective pair of annihilation radiations to reach.

5. A coincidence determination apparatus for a PET device, comprising:
a plurality of radiation detectors for detecting radiations occurring from a nuclide;
means for detecting detection times of radiations in the respective radiation detectors;
means for determining a coincidence to be present when a difference in detection time between a plurality of the radiation detectors is within a predetermined time; and
means for changing a coincidence time width according to a maximum detection time difference.

6. The coincidence determination apparatus for a PET device according to claim 5, wherein the maximum detection time difference is calculated in advance according to a geometrical arrangement of detectors and a size of a field of view.

7. The coincidence determination apparatus for a PET device according to claim 5, wherein the maximum detection time difference is calculated in advance according to a ring difference that is a distance between detector rings for the respective pair of annihilation radiations to reach.

8. A coincidence determination apparatus for a PET device including:
a plurality of radiation detectors for detecting radiations occurring from a nuclide;
means for detecting detection times of radiations in the respective radiation detectors;
means for determining a coincidence to be present when a difference in detection time between a plurality of the radiation detectors is within a predetermined time; and
means for changing a coincidence time width according to a ring difference that is a distance between detector rings for a respective pair of annihilation radiations to reach.
